(19) United States
(12) Patent Application Publication
(10) Pub. No.: US 2008/0164448 A1
(43) Pub. Date: Jul. 10, 2008

(54) Frame mounted side winch for trucks

(76) Inventor: Carnel C. Duvall, Quinton, OK (US)

Correspondence Address: Carnel C. Duvall, PO Box 355, Quinton, OK, 74561, US

(21) Appl. No.: 12/006,905

(22) Filed: Jan. 7, 2008

Related U.S. Application Data
(60) Provisional application No. 60/879,059, filed on Jan. 8, 2007.

(51) Int. Cl. B66D 1/00

(52) U.S. Cl. 254/323

(57) ABSTRACT

A vehicle positioning device that installs onto the side of the frame of a heavy duty rollback wrecker vehicle and is capable of winching a wrecked vehicle onto the shoulder of a roadway so that the wrecked vehicle is aligned parallel with the roadway, i.e. the desired position to be safely loaded onto the rollback wrecker vehicle. The device is provided with a winch and attached cable and hook for winching a wrecked vehicle in a direction approximately perpendicular to the longitudinal axis of the rollback wrecker vehicle. The winch is hydraulically powered by tapping into the existing hydraulic system provided on the rollback wrecker vehicle.

### CROSS-REFERENCE TO RELATED APPLICATIONS

The Application claims the benefit of Provisional Patent No. 60/879,059 filed Jan. 8, 2007.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a frame mounted winching device primarily used on large heavy duty rollback wreckers for recovery and positioning wrecked vehicles involved in accidents. These wrecked vehicles came to rest off the highway either in ditches or through fences far enough away from the highway to require recovery vehicles to winch them back to the roadway for loading.

Presently when a rollback wrecker is called to the scene of an accident, the vehicle is usually not in a good position for loading. The wrecker operator must first reposition the wrecked vehicle parallel with the roadway.

This repositioning may only require sliding the front or rear of the wrecked vehicle a few feet sideways to align it with the roadway, or at other times the wrecked vehicle may have come to rest a hundred feet off the roadway and must be winched back to the roadway and positioned parallel with the roadway before loading.

Unlike conventional wrecker vehicles, rollback wreckers are flatbed car transport vehicles and are designed to load a vehicle onto the bed of the rollback wrecker by first positioning the rollback wrecker in front of the vehicle to be loaded and in parallel alignment therewith, second lowering the rollback wrecker bed to the roadway, third unwinding the cable from the winch mounted in the front of the bed, fourth connecting it to the vehicle, and finally winching the vehicle to the front of the bed. The wrecked vehicle is then secured with chains and the bed rolled forward for transport. Rollback wrecker beds are not designed to pull a vehicle at an angle to the longitudinal axis of the wrecker. Winching a wrecked vehicle with the front bed winch in a direction perpendicular to the longitudinal axis of the rollback wrecker can result in serious damage by warping the rollback bed.

Presently this job is done in a variety of ways. Three of which can be accomplished without blocking both lanes of the roadway. One is with my patented rollback wrecker vehicle positioning device, U.S. patent No. U.S. Pat. No. 6,543,749 B1. In which a trade name “Rollback Sidewinder” unit is mounted directly to the truck frame and under the rollback wrecker bed. This method works great on small light duty rollback wreckers which it was designed for and requires an outrigger system for stability because of their small frames and lack of weight. However, almost every wrecker company is replacing their 12,500 gross vehicle weight, older, smaller light duty wreckers with new low profile heavy duty rollback wrecker vehicles with a gross vehicle weight just under 26,000 lbs. These new wreckers weighing more than twice the weight of a light duty wrecker are stable enough to pull a 4,000 lbs. car without having the outriggers. This invention provides operators of heavy duty rollback wrecker vehicles the equipment to perform the same side pulling operations at a much lower cost making it affordable for everyone.

A second way to do this with a rollback wrecker is mount a sidepuller unit behind the cab which has one outrigger on each side for stability. The down side to this is that it takes up valuable bed space, plus the heavy weight, and expensive price.

A third way is installing a side puller socket and sheave in the center of the bed about three feet from the back. This has disastrous effects also by warping the rollback bed. Since rollback beds slide on rollers or rails, they warp very easily and are expensive to repair, especially if they are made of aluminum.

Having a wrecked vehicle positioned at an angle to the roadway presents a problem when attempting to load the wrecked vehicle onto the rollback wrecker vehicle because the rollback wrecker vehicle must be aligned parallel and in front of the wrecked vehicle in order to successfully load the vehicle onto the bed of the rollback wrecker vehicle. If the wrecked vehicle is at an angle to the roadway, this requires the rollback wrecker vehicle to also position itself at an angle to the roadway in order to load the vehicle onto the bed of the rollback wrecker. The bed of a rollback wrecker is a minimum of seventeen feet long and usually has a combined truck and bed length of over thirty feet when in the transport position and several feet longer when in a loading position.

Anytime a rollback wrecker has both lanes on the roadway blocked you have a very dangerous situation. For this reason some State Departments of Public Safety required that wrecker services must have a conventional wrecker also if they are to be on the Department of Public Safety wrecker rotation list to work wrecks investigated by the Highway Patrol. Highway Patrol Officers like to keep at least one lane of the highway open to lower the danger risk and also for convenience. If the rollback wrecker vehicle is in the middle of the road with both lanes blocked during the loading process, oncoming traffic may strike the rollback wrecker, its operator, or the officer investigating the accident.

This can be particularly dangerous when the weather is bad, the roadway is slick or icy, the road is curved or hilly, or when visibility is poor, such as early morning, when foggy, or at night.

Because of dangers currently involved in loading a wrecked vehicle in an unfavorable position on a rollback wrecker traffic authorities at the scene of an accident often insist that a conventional wrecker also respond to the accident to make the recovery and position the wrecked vehicle parallel with the roadway for loading so one lane of the highway can remain open for continuous traffic flow. This results in wasted time for the officer and operator, and higher costs for the customer.

The present invention allows a heavy duty rollback wrecker vehicle to safely execute a side pull that will position the wrecked vehicle on the shoulder of the roadway aligned parallel with the road so that it can be safely loaded onto the rollback wrecker vehicle. With the wrecked vehicle in this ideal position, the rollback wrecker can then be moved onto the shoulder of the road in front of the wrecked vehicle and out of the line of traffic. Next, the bed of the rollback wrecker vehicle is lowered to the roadway, and the wrecked vehicle can then be pulled straight ahead onto the bed of the rollback wrecker vehicle. Once the wrecked vehicle is loaded, it is secured with chains, the bed of the rollback wrecker vehicle is moved forward, and the wrecked vehicle is ready for transport.

This invention is designed for safety and convenience. In some cases the inventions job is to only slide the front or rear of a wrecked vehicle a few feet for ideal loading. While in other cases winching over one hundred feet is required. The present invention is able to do the job safely without damage to the rollback wrecker bed at the scene instead of calling for another truck to assist. Another object of the invention is to align the wrecked vehicle with the roadway as it is being winched sideways toward the side of the rollback wrecker. This invention does cure the one fault of the rollback wrecker: it's length.

The old way of using a conventional wrecker to recover and position the wrecked vehicle for loading on the rollback transport vehicle is still used today. However, using that method without crossing the centerline is difficult because as mentioned before wrecker companies are buying heavier longer trucks for conventional wreckers also, plus the added operational cost of having two trucks and two operators at the scene adds to the risk of another accident.

The present invention was invented due to the changes in new trucks used to make rollback wreckers in the past few years. Now you can buy trucks with your choice of engines from the stock engine to the optional engines such as Cummins or Caterpillar. Now you can choose the wheel size from 16 to 24.5 and several in between. Several optional frames can also be ordered allowing the wrecker company to buy a very heavy duty low profile rollback wrecker strong enough to withstand winching directly from the frame mounted side winch. The rollback wreckers hydraulic value system is equipped with an adjustable relief valve allowing the operator to determine the amount the winch will pull before the bypass valve will open, therefore making it impossible to cause damage to the truck during operations.

Due to the recent changes in tow trucks with heavy frames and other options this present invention came into being. This device can now be bolted onto the heavy rollback wreckers without the use of outriggers.

This new device to the towing industry will make the operators job much easier at a very low cost. This invention uses a modified winch capable of holding twice the amount of cable it holds from the factory. When fitted with cable, hook, and special chain this invention with a wireless remote control is another step forward in the fight for safety and convenience at the scene of accidents.

### BRIEF SUMMARY OF THE INVENTION

The present invention is a vehicle positioning and recovery device. The winch on this device is powered by hydraulic fluid from the existing hydraulic power system on the truck. Another embodiment of the device can be electric powered from the trucks electrical system. Both units can be controlled by wireless remote. The hydraulic version is the preferred embodiment. This winching unit bolts directly to the truck frame and it's pulling limit is adjustable and determined by the setting of the trucks hydraulic relief valve therefore eliminating risk of causing damage to the wrecker by over pulling.

This invention solves the problem of keeping one lane of the highway open while working off-road accidents.

Operators can safely winch wrecked vehicles back to the roadway and position them in exact position for loading. This can be accomplished with a wireless remote allowing the operator to be out of the truck, with his eyes on the vehicle and in a much safer place.

This invention makes accident scenes safer and working them more efficient at a very low cost and the roadway always has one lane open for traffic.

### BRIEF DESCRIPTION OF THE SEVERAL VIEWS OF THE DRAWINGS

FIG. 1 is a top view of a frame mounted side winch for trucks.

FIG. 2 is a front view of a frame mounted side winch for trucks.

FIG. 3 is a side view of a frame mounted side winch for trucks.

### PARTS NUMBER LIST

1 Backplate
2 Attaching Bar
3 Mounting Bolt
4 Mounting Nut
5 Spool Release Lever
6 Winch Sideplate
7 Winch Motor
8 Forward Hydraulic Hose
9 Reverse Hydraulic Hose
10 Cable
11 Hook
12 Winch Housing

### DETAILED DESCRIPTION OF THE INVENTION

The present invention is a frame mounted winching and positioning device primarily made for the towing industry. This device when mounted on a heavy duty rollback wrecker allows the operator to be out of the truck while performing winching operations.

The rollback wrecker is parked in the roadway with emergency lights on where it remains until the wrecked vehicle is in perfect position to be loaded. The operator controls the winching operations with cable, chains, and the optional wireless remote. Being out of the truck is safer for the operator and allows him to make better judgments since he can position himself a safe distance away but within sight of the vehicle being winched. Safety is the number one priority and with this device one lane of the roadway is always open for traffic as law enforcement officers prefer and sometimes demand.

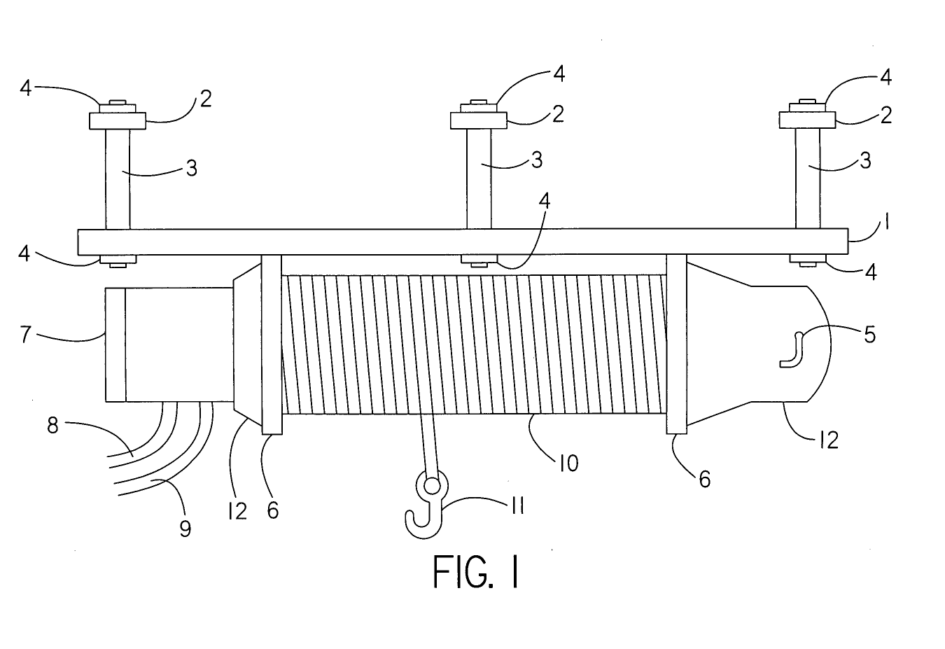

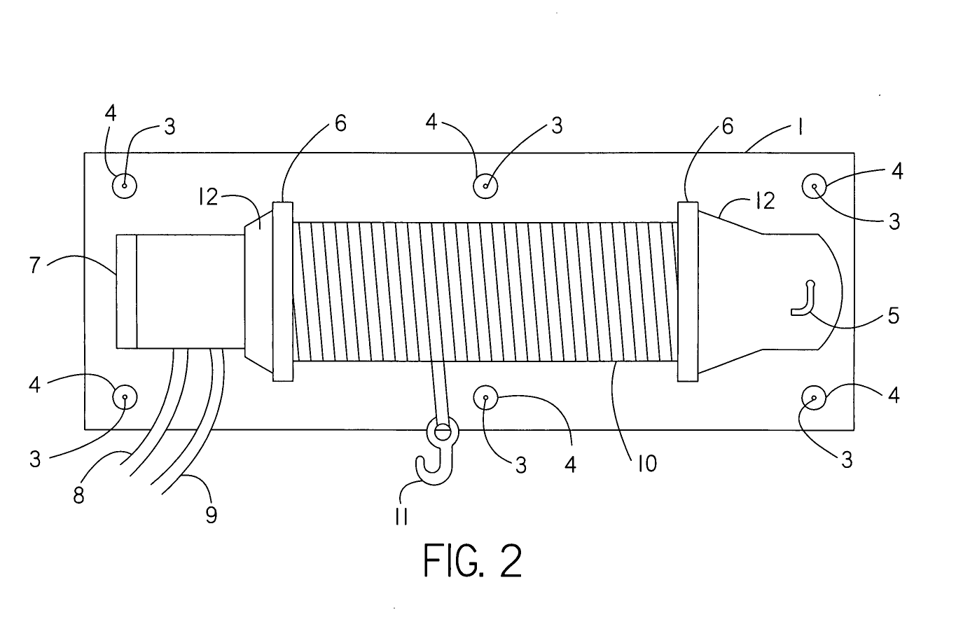

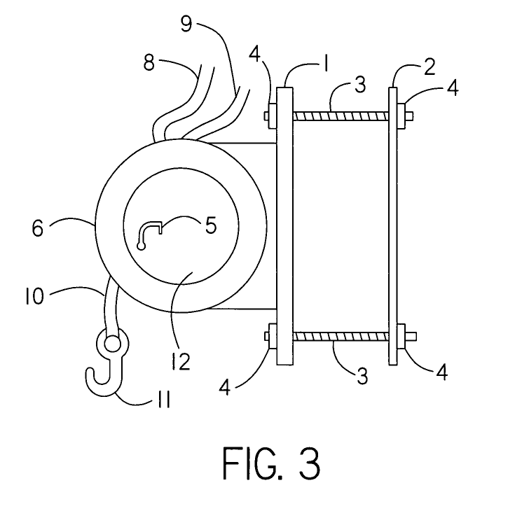

Referring now to the drawings and initially to FIG. 1, there is illustrated a top view of a Frame Mounted Side Winch For Trucks constructed in accordance with a preferred embodiment of the present invention. As illustrated also in FIG. 2, the front view of the device and FIG. 3, a side view of the Frame Mounted Side Winch For Trucks. This invention is made starting with the backplate 1 which is cut from ¾ inch steel plate. The backplate 1 is 14 inches tall and 30 inches wide and has six holes for mounting the winch housing 12 and winch sideplates 6 to the backplate 1. These holes are drilled with a 45/64 drill and then tapped to receive ¾ inch bolts. Next we attach the winch housing 12 and winch sideplates 6 to the backplate 1. An additional six more holes are drilled in the backplate 1 with a ⅞ inch bit to receive the six bolts that mount the backplate 1 to the truck frame.

Another part used in mounting the backplate 1 to the truck frame is the three attaching bars 2. These three attaching bars 2 are made from 1 inch×2 inch steel strap and are each 14 inches long with two ⅞ inch diameter holes drilled in the attaching bars one inch from each end. The backplate 1 is now ready to be attached to the truck frame using mounting bolts 3 cut 7 inches long and mounting nuts 4.

The backplate 1 is then lifted to the truck frame height and the six ¾ inch grade 8 mounting bolts 3 are pushed through the backplate 1 and attaching bars 2. The six ¾ inch mounting nuts 4 are then screwed on and tightened. This completes the mounting of the device to the truck frame.

After mounting the device to the truck frame the ⅜ inch winch cable 10 and hook 11 are installed on the winch. The winch motor 7 is then connected to the trucks hydraulic system with the forward hydraulic hose 8 and reverse hydraulic hose 9. The winch is also equipped with a spool release lever 5 for speed in operation.

This device was invented for larger heavy duty wreckers to assist in recovery and positioning wrecked vehicles for loading without blocking both lanes of the roadway.

It's use varies from accident to accident however most wrecker companies have changed their rollback wreckers from one ton trucks with a gross vehicle weight of 12,500 lbs to the larger heavier trucks that are rated at 25,999 gross vehicle weight. The truck manufacturers have kept the gross vehicle weight just under the 26,000 gross vehicle weight so wrecker drivers are not required to have commercial driving licenses. However, most of these trucks are very big and heavy having several motor choices, frame choices and tire size choices. Looking at the large weight and size of these vehicles gave me the idea of attaching a small modified hydraulic winch directly on the side frame of these trucks. I already have a patent on a similar device that has an extensive stabilizing system for small light duty trucks, U.S. Pat. No. 6,543,749 B1, which works well on smaller trucks with lighter frames and 12,500 gross vehicle weight.

Wrecker companies are buying larger and heavier trucks today which do not require outriggers for stability due to their heavy weight and size. These trucks can do side winching and positioning jobs with my new invention without outriggers for stabilizing the truck.

To use the Frame Mounted Side Winch for Trucks the driver responding to the call drives up on the scene and parks the wrecker in his lane leaving the other lane open for traffic. He turns on the warning lights and engages the hydraulic system. The driver picks up the wireless remote and exits the truck.

Next, he disengages the spool release leaver on the winch which frees the cable which can then be pulled to the wrecked vehicle. Next he hooks up the wrecked vehicle with a chain and connects the cable hook to the chain. He then returns to the truck side winch and engages the spool release leaver. He then moves a safe distance away and winches the wrecked vehicle to the roadway shoulder by using the wireless remote control. If the vehicle does not respond to winching as it should he will then move the cable hook to another location for better results.

The vehicle is winched to the shoulder and the chain removed. The driver then enters the wrecker and positions it in the front of the vehicle for loading. The bed is then lowered and rolled back and the wrecked vehicle is winched on the bed and secured with chains. The bed is then rolled forward and ready for transport. All of this was done with a small inexpensive winching device mounted on the side frame on a heavy duty rollback wrecker. The accident scene is made safer and one lane for traffic kept open like highway patrol officers prefer to see it done.

While the invention has been described with a certain degree of particularity, it is manifest that many changes may be made in the details of construction and the arrangement of components without departing from the spirit and scope of this disclosure.

It is understood that the invention is not limited to the embodiments set forth herein for the purposes of exemplification, but is to be limited only by the scope of the attached claim or claims, including the full range of equivalency to which each element thereof is entitled.

What is claimed is:

1. A combination frame mounted side winch and rollback wrecker truck for moving and positioning disabled vehicles into desired loading position comprising:
a wrecker vehicle having a spring supported chassis and a rollback wrecker bed mounted on said chassis,
means for attaching a winching apparatus with cable and hook to the frame of a rollback wrecker truck for moving disabled vehicles into parallel position on a roadway shoulder for safe and convenient loading.
